(19) United States
(12) Patent Application Publication
(10) Pub. No.: US 2026/0219158 A1
(43) Pub. Date: Jul. 30, 2026

(54) Flow Cytometry System and Methods for Use

(71) Applicant: Sartorius BioAnalytical Instruments, Inc., Bohemia, NY (US)

(72) Inventors: Jason Barrett, Bohemia, NY (US); Jeremy Lefebvre, Bohemia, NY (US); Silverio Reyes, Bohemia, NY (US); Gerald Coleman, Bohemia, NY (US); Zachary Kane, Bohemia, NY (US); Austin Ngo, Bohemia, NY (US); Gerardo Huerta, Bohemia, NY (US); Xinyi Zhou, Bohemia, NY (US); Dongyul Chai, Bohemia, NY (US); Anssi Häärä, Bohemia, NY (US)

(21) Appl. No.: 19/220,767

(22) Filed: May 28, 2025

Related U.S. Application Data
(60) Provisional application No. 63/749,367, filed on Jan. 24, 2025.

(51) Int. Cl. G01N 15/1429; G01N 15/0205

(52) U.S. Cl. CPC G01N 15/1429; G01N 15/0205

(57) ABSTRACT

The present disclosure provides flow cytometry system. The flow cytometry system includes a flow cell, a sample fluidic pathway in fluid communication with the flow cell, and a probe in fluid communication with the sample fluidic pathway. The probe is configured to input a plurality of samples and aliquots of a separation gas between successive ones of the plurality of samples into the sample fluidic pathway. The flow cytometry system also includes a bubble sensor positioned on the sample fluidic pathway and a visual indicator. The flow cytometry system also includes a processor and a non-transitory computer readable medium having stored therein instructions that are executable to cause the processor to perform functions when using the flow cytometry system. The functions include (i) determining, via the bubble sensor positioned on the sample fluidic pathway, a presence of the separation gas in the fluid in the sample fluidic pathway, and (ii) based on the determination of the presence of the separation gas, transitioning the visual indicator from a first visual state to a second visual state.

### CROSS-REFERENCE TO RELATED APPLICATIONS

This application claims priority to U.S. Provisional Application No. 63/749,367 entitled “Flow Cytometry System and Methods for Use,” filed on Jan. 24, 2025, the contents of which are hereby incorporated by reference in its entirety.

### BACKGROUND

Flow cytometry is a technology employed in cell counting, cell sorting, biomarker detection and protein engineering, for example, conducted by suspending cells in a stream of fluid and passing them through an electronic detection apparatus. Flow cytometry allows simultaneous multiparametric analysis of the physical and/or chemical characteristics of up to tens of thousands of particles per second. Traditionally, flow cytometers are standalone instruments designed to measure biological samples which are in aqueous suspensions contained in assay plates or vials, and may be capable of actively separating and isolating particles that have properties of interest. As such, they are typically independent lab instruments. An operator (or robotic device) presents the sample(s) to the cytometer, the cytometer performs its measurements, and the cytometer reports the results to the operator. Traditionally, flow cytometry has been used for low-throughput sample analysis by placing samples, one-by-one, under the sampling port of the cytometer.

More recently, high-throughput flow cytometry systems have been developed to quickly deliver samples at microliter volumes to the flow cytometry engine. High-throughput flow cytometry systems use a pump system to fill a sample tubing line with a stream of discrete sample particle suspensions aspirated from wells of a microplate and separated one from the other by gas or air bubble gaps. The entire sample stream is continuously delivered to the flow cytometer so that data from all the samples in the microplate are acquired and stored in a single data file. A high-resolution time parameter is also recorded during data acquisition. The present disclosure provides various improvements for high-throughput flow cytometry systems.

### SUMMARY

In a first aspect, the present disclosure provides flow cytometry system comprising: (a) a flow cell, (b) a sample fluidic pathway in fluid communication with the flow cell, (c) a probe in fluid communication with the sample fluidic pathway, wherein the probe is configured to input a plurality of samples and aliquots of a separation gas between successive ones of the plurality of samples into the sample fluidic pathway, (d) a bubble sensor positioned on the sample fluidic pathway, (e) a visual indicator, (f) a processor, and (g) a non-transitory computer readable medium having stored therein instructions that are executable to cause the processor to perform functions when using the flow cytometry system, including: (i) determining, via the bubble sensor positioned on the sample fluidic pathway, a presence of the separation gas in the fluid in the sample fluidic pathway; and (ii) based on the determination of the presence of the separation gas, transitioning the visual indicator from a first visual state to a second visual state.

In a second aspect, the present disclosure provides a fluid storage module configured to be in fluid communication with a flow cytometry system, the fluid storage module comprising: (a) a housing, (b) a first tank positioned within the housing and configured to receive a first liquid via a first fluidic pathway, (c) a first load cell positioned within the housing and beneath the first tank, (d) a second tank positioned within the housing and configured to transmit a second liquid via a second fluidic pathway, (e) a second load cell positioned within the housing and beneath the second tank, and (f) a pump in fluid communication with the first tank, wherein the pump is configured to remove the first liquid from the first tank via the first fluidic pathway.

In a third aspect, the present disclosure provides flow cytometry system comprising: (a) a flow cell, (b) a sample fluidic pathway in fluid communication with the flow cell, (c) a sheath fluidic pathway in fluid communication with the flow cell, (d) a probe having a first end and a second end opposite the first end, wherein the second end of the probe is in fluid communication with the sample fluidic pathway, (e) a processor, and (f) a non-transitory computer readable medium having stored therein instructions that are executable to cause the processor to perform functions when using the flow cytometry system, including: (i) detecting a presence of a particle in the sheath fluidic pathway, (ii) detecting a pressure and/or a flow rate in the sheath fluidic pathway, and (iii) based on the detected presence of the particle in the sheath fluidic pathway and the detected pressure and/or flow rate in the sheath fluidic pathway, adjusting one or more parameters of a fluid within the sheath fluidic pathway to thereby clean the sheath fluidic pathway.

In a fourth aspect, the present disclosure provides a method. The method includes (a) detecting a presence of a particle in a fluidic pathway, (b) detecting a pressure and/or a flow rate in the fluidic pathway, and (c) based on the detected presence of the particle in the fluidic pathway and the detected pressure and/or flow rate in the fluidic pathway, adjusting one or more parameters of a fluid within the fluidic pathway to thereby clean the fluidic pathway.

The features, functions, and advantages that have been discussed can be achieved independently in various examples or may be combined in yet other examples, further details of which can be seen with reference to the following description and figures.

### BRIEF DESCRIPTION OF THE DRAWINGS

The novel features believed characteristic of the illustrative examples are set forth in the appended claims. The illustrative examples, however, as well as a preferred mode of use, further objectives and descriptions thereof, will best be understood by reference to the following detailed description of an illustrative examples of the present disclosure when read in conjunction with the accompanying figures.

FIG. 1 illustrates a schematic of an example flow cytometry system, according to an example embodiment.

FIG. 2 illustrates a schematic of an example bubble detection system, according to an example embodiment.

FIG. 3 illustrates an example bubble sensor, peristaltic pump, and visual indicator, according to an example embodiment.

FIG. 4 illustrates an example workstation including the flow cytometry system, according to an example embodiment.

FIG. 5 illustrates an example flow cytometry system with a side covering removed, according to an example embodiment.

FIG. 6 illustrates a gantry system of an example flow cytometry system, according to an example embodiment.

FIG. 7 illustrates a rinse station of an example flow cytometry system, according to an example embodiment.

FIG. 8 illustrates an engine of an example flow cytometry system, according to an example embodiment.

FIG. 9 illustrates a fluidics station of an example flow cytometry system, according to an example embodiment.

FIG. 10 illustrates controllers of an example flow cytometry system, according to an example embodiment.

FIG. 11 illustrates various features of the enclosure of an example flow cytometry system, according to an example embodiment.

FIG. 12 illustrates a sample door lock of an example flow cytometry system, according to an example embodiment.

FIG. 13 illustrates a laser interlock of an example flow cytometry system, according to an example embodiment.

FIG. 14A illustrates a probe and tubing of an example flow cytometry system, according to an example embodiment.

FIG. 14B illustrates a close up view of the probe of FIG. 14A, according to an example embodiment.

FIG. 14C illustrates a fluidlink connector, according to an example embodiment.

FIG. 14D illustrates a flexible sample tubing support, according to an example embodiment.

FIG. 14E illustrates a close up view of the flexible sample tubing support of FIG. 14D, according to an example embodiment.

FIG. 15 illustrates a visual representation of a connection of the fluidlink connector to the flow cell on one side and the tubing on the other side, according to an example embodiment.

FIG. 16 illustrates a probe mount of an example flow cytometry system, according to an example embodiment.

FIG. 17 illustrates a visual representation of the probe being positioned in the probe mount, according to an example embodiment.

### DETAILED DESCRIPTION

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts were described in conjunction with specific examples, it will be understood that these examples are not intended to be limiting. All examples of any aspect of the invention can be used in combination, unless the context clearly dictates otherwise.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one embodiment” or “one example” means that one or more feature, structure, or characteristic described in connection with the example is included in at least one implementation. The phrases “one embodiment” or “one example” in various places in the specification may or may not be referring to the same example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Example methods and systems are described herein. It should be understood that the words “example,” “exemplary,” and “illustrative” are used herein to mean “serving as an example, instance, or illustration.” Any example or feature described herein as being an “example,” being “exemplary,” or being “illustrative” is not necessarily to be construed as preferred or advantageous over other examples or features. The examples described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to”. Words using the singular or plural number also include the plural and singular number, respectively.

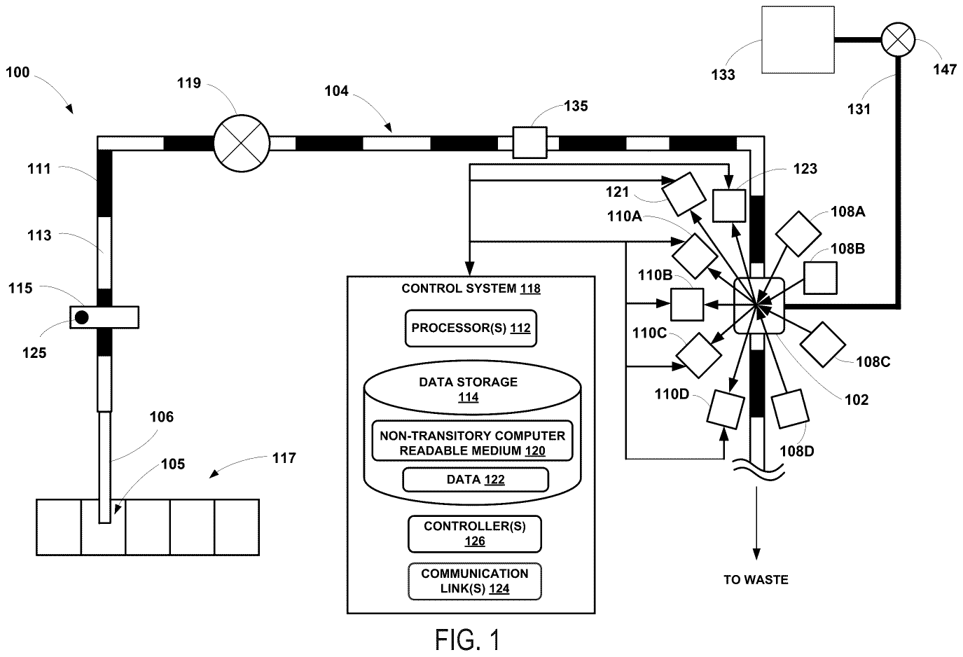

In FIG. 1, referred to above, solid lines, if any, connecting various elements and/or components may represent mechanical, electrical, fluid, optical, electromagnetic and other couplings and/or combinations thereof. As used herein, “coupled” means associated directly as well as indirectly. For example, a member A may be directly associated with a member B, or may be indirectly associated therewith, e.g., via another member C. It will be understood that not all relationships among the various disclosed elements are necessarily represented. Accordingly, couplings other than those depicted in the block diagrams may also exist. Dashed lines, if any, connecting blocks designating the various elements and/or components represent couplings similar in function and purpose to those represented by solid lines; however, couplings represented by the dashed lines may either be selectively provided or may relate to alternative examples of the present disclosure. Likewise, elements and/or components, if any, represented with dashed lines, indicate alternative examples of the present disclosure. One or more elements shown in solid and/or dashed lines may be omitted from a particular example without departing from the scope of the present disclosure. Environmental elements, if any, are represented with dotted lines. Virtual (imaginary) elements may also be shown for clarity. Those skilled in the art will appreciate that some of the features illustrated in FIG. 1 may be combined in various ways without the need to include other features described in FIG. 1, other drawing figures, and/or the accompanying disclosure, even though such combination or combinations are not explicitly illustrated herein. Similarly, additional features not limited to the examples presented, may be combined with some or all of the features shown and described herein.

For the purposes of the present invention, the term “particles” as used herein refers to small objects with physical size between 1 nm and 1 mm including, but not limited to, molecules, cells, proteins, protein aggregates, microbes, viruses, microspheres, microbeads, cellular components such as nuclei, mitochondria, chemical compounds, and chemical aggregates, etc.

As used herein “sample” refers to any quantity of liquid which may contain particles of interest or marker particles that are detectable by a particle analyzer. More specifically a sample may include a fluid solution or suspension containing particles of interest or marker particles to be detected and/or analyzed using a method and/or apparatus disclosed herein. The particles of interest in a sample may be tagged, such as with a fluorescent tag. The particles of interest may also be bound to a bead, a receptor, or other useful protein or polypeptide, or may just be present as free particles, such as particles found naturally in a cell lysate, purified particles from a cell lysate, particles from a tissue culture, etc. The sample may include chemicals, either organic or inorganic, used to produce a reaction with the particles of interest. When the particles of interest are biomaterials, drugs may be added to the samples to cause a reaction or response in the biomaterial particles. The chemicals, drugs or other additives may be added to and mixed with the samples when the samples are in sample source wells or the chemicals, drugs or other additives may be added to the samples in the fluid flow stream after the samples have been uptaken by the autosampler.

For the purposes of the present invention, the term “well” as used herein may include any vessel for containing a sample, such as a chamber, dish, tube, bottle, vial, reservoir trough, or a well on a microtiter plate.

As used herein “microplate” and “plate” refer to a structure capable of holding one or more samples to be analyzed or aliquot of marker particles.

As used herein, the term “fluidic pathway” or “conduit” refers to device such as a tube, channel, etc. through which a fluid stream flows. A fluidic pathway may be composed of several separate devices, such as a number of connected or joined pieces of tubing or a single piece of tubing, alone or in combination with channels or other different devices.

By the term “about,” “approximately,” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, in one embodiment, the term “about” can refer to ±5% of a given value.

Various other features of the example systems discussed above, as well as methods for using these systems, are also described hereinafter with reference to the accompanying figures. Illustrative, non-exhaustive examples, which may or may not be claimed, of the subject matter according the present disclosure are provided below.

With reference to the Figures, FIG. 1 illustrates an example flow cytometry system 100. As shown in FIG. 1, the flow cytometry system 100 includes a flow cell 102 and a sample fluidic pathway 104 (also referred to as tubing 104 or sample tubing 104) in fluid communication with the flow cell 102. The flow cytometry system 100 further includes a probe 106 in fluid communication with the sample fluidic pathway 104. The probe is configured to input a plurality of samples and aliquots of a separation gas between successive ones of the plurality of samples into the sample fluidic pathway 104. The flow cytometry system 100 further includes two or more lasers 108A-108D positioned such that an illumination spot of each of the two or more lasers 108A-108D is directly on the flow cell 102. The flow cytometry system 100 further includes two or more side scatter detection modules 110A-110D in communication with the two or more lasers 108A-108D. Although FIG. 1 illustrates the number of the two or more lasers and the number of the two or more side scatter detection modules to be four, this number may be two, three, four, or five as non-limiting examples.

In operation, the probe 106 may take up a sample 111 from a sample well 105 in the well plate 117, for example, and then advance the sample 111 into the sample fluidic pathway 104. A pump 119 may then drive a fluid flow stream including samples 111 from the well 105 through the sample fluidic pathway 104 to the flow cell 102. In such an embodiment, the flow cell 102 is in fluid communication with the probe 106 via the sample fluidic pathway 104, and the flow cytometry system 100 is configured to focus the fluid flow stream delivered by the sample fluidic pathway 104 from the probe 106 and selectively analyze the particles in each of the plurality of samples 111 as the fluid flow stream passes through the flow cell 102. Further, the flow cytometry system 100 includes a sheath fluidic pathway 131 in fluid communication with a sheath reservoir 133. A sheath pump 147 is configured to drive sheath fluid from the sheath reservoir 133, through the sheath fluidic pathway 131, and to the flow cell 102 to thereby ensure that the samples 111 are separated individually before interrogation in the flow cell 102. The flow cytometry system 100 further includes a first sensor 135 positioned on the sheath fluidic pathway 131, a second sensor 137 positioned on the sheath fluidic pathway 131, and a filter 140 positioned on the sheath fluidic pathway 131 between the first sensor 135 and the second sensor 137.

As discussed above, the flow cytometry system 100 further includes two or more lasers 108A-108D positioned such that an illumination spot of each of the two or more lasers 108A-108D is directly on the flow cell 102. The two or more lasers 108A-108D are configured to examine individual samples flowing from the flow cell 102, as discussed in additional detail below. When samples 111 pass through the illumination spot of two or more lasers 108A-108D, the particles in the samples 111 are sensed by various components of the flow cytometry system 100. Forward scattered light is detected by one or more forward scatter detectors 121. Fluorescence emitted from tagged particles in the flow cell 102 is detected by one or more fluorescence detectors 123. In one example, the one or more fluorescence detectors 123 comprise one or more photomultiplier detectors. Side scattered light is detected by the two or more side scatter detection modules 110A-110D. In contrast, when the separation gas 113 passes through the illumination spot of two or more lasers 108A-108D, no particles are sensed. Therefore, a graph of the data points of fluorescence sensed versus time for a series of samples analysed using a flow cytometer will form distinct groups, each aligned with the time that a sample containing particles passes through the illumination spot of two or more lasers 108A-108D. Such graphs can be generated by the output of the one or more forward scatter detectors 121, the one or more fluorescence detectors 123, and/or the one or more side scatter detection modules 110A-110D.

In one example, the pump 119 comprises a peristaltic pump. In one embodiment, such a peristaltic pump may be operated in a manner that reduces pulsatile flow, thereby improving the sample characteristics in the flow cytometry system 100. In another embodiment, the pump 119 comprises a gear pump. In yet another example, the pump comprises a syringe pump. Although the pump 119 is shown before the flow cell 102 in FIG. 1, in another embodiment the pump 119 may be positioned downstream of the flow cell 102. Further, additional pumps may be added to the flow cytometry system 100 to perform various functions. For example, a combination of one or more peristaltic pumps, one or more gear pumps, and/or one or more syringe pumps may be used to transport samples through the sample fluidic pathway 104.

In one embodiment, the sample fluidic pathway 104 may be made of an elastomer tubing, such as nitrile (NBR), Hypalon, Viton, silicone, polyvinyl chloride (“PVC”), Ethylene-Propylene-Diene-Monomer (“EPDM”), EPDM+polypropylene, polyurethane or natural rubber, among other possibilities. An example of such a tube may be a polyvinyl chloride (PVC) tube having an inner diameter of about 0.2 mm to about 0.75 mm and a wall thickness of about 0.6 mm to about 1.1 mm. In one embodiment, a preferred tube for a sample fluidic pathway 104 may be a PVC tube having an inner diameter of about 0.25 mm and a wall thickness of about 0.875 mm.

As shown in FIG. 1, sample fluidic pathway 104 includes a fluid flow stream with a series of samples 111 each separated by aliquots of a separation gas 113, such as an air bubble as a non-limiting example. The separation gas 113 may be formed by allowing probe 106 to intake air (or other gas) in between intaking sample material from each of sample wells 105. As such, the probe 106 is used introduce aliquots of the separation gas 113 between successive ones of the samples 111 in the fluid flow stream to configure the fluid flow stream in the sample fluidic pathway 104 as a separation gas-separated fluid flow stream. In use, temporal gaps in particle detection are created in the data stream by the passage of the aliquots of the separation gas 113, allowing the individual particle suspensions to be distinguished and separately evaluated when plotted in conjunction with the time parameter. Based on this temporal distribution, data peaks are identified and assigned to individual wells 105 of the well plate 117.

As further shown in FIG. 1, the flow cytometry system 100 may include a bubble sensor 115 positioned on the sample fluidic pathway 104 and a visual indicator 125, which are discussed in additional detail below. In one example, the visual indicator 125 is positioned adjacent to the bubble sensor 115. The flow cytometry system 100 may further include processor(s) 112, data storage 114, and controller 126, which together may be part of a control system 118. Processor(s) 112 may operate as one or more general-purpose hardware processors or special purpose hardware processors (e.g., digital signal processors, application specific integrated circuits, etc.). The processor(s) 112 may be configured to execute non-transitory computer readable medium 120, and manipulate data 122, both of which are stored in the data storage 114. The processor(s) 112 may also directly or indirectly interact with other components of the flow cytometry system 100, such as communication link(s) 124 as a non-limiting example.

The data storage 114 may be one or more types of hardware memory. For example, the data storage 114 may include or take the form of one or more computer-readable storage media that can be read or accessed by processor(s) 112. The one or more computer-readable storage media can include volatile and/or non-volatile storage components, such as optical, magnetic, organic, or another type of memory or storage, which can be integrated in whole or in part with processor(s) 112. In some implementations, the data storage 114 can be a single physical device. In other implementations, the data storage 114 can be implemented using two or more physical devices, which may communicate with one another via wired or wireless communication. As noted previously, the data storage 114 may include the non-transitory computer readable medium 120 and the data 122. The data 122 may be any type of data from the flow cytometry system 100, such as configuration data, sensor data, and/or diagnostic data, among other possibilities.

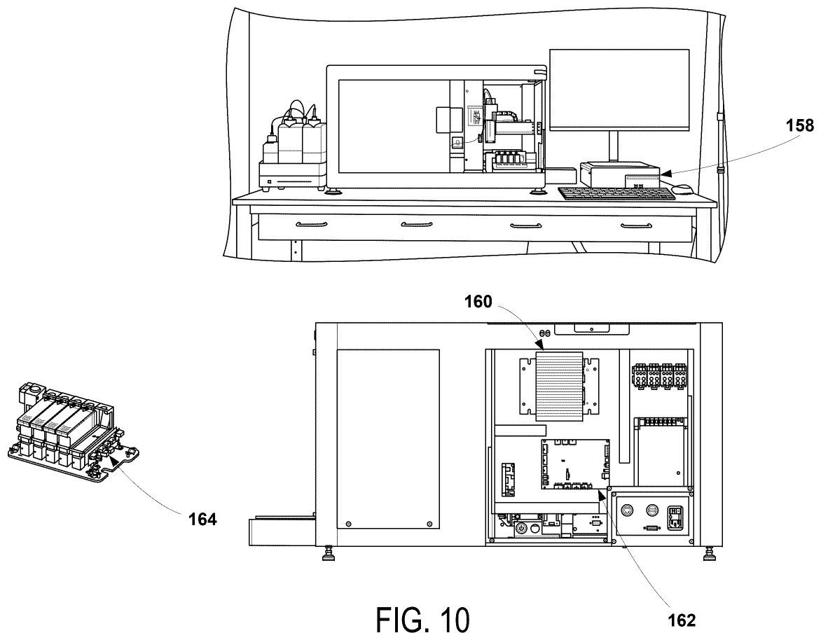

The controller 126 may include one or more electrical circuits, units of digital logic, computer chips, and/or microprocessors that are configured to (perhaps among other tasks), interface between any combination of the various components of the flow cytometry system 100. In some implementations, the controller 126 may be a purpose-built embedded device for performing specific operations with one or more subsystems of the flow cytometry system 100. As used herein and shown in FIG. 10, for example, the controller 126 may comprise one or more of the instrument controller 158, the embedded computer 160, the master controller 162, and the rinse station controller 164, as discussed in additional detail below.

The control system 118 may monitor and physically change the operating conditions of the flow cytometry system 100. In doing so, the control system 118 may serve as a link between portions of the flow cytometry system 100. In some instances, the control system 118 may serve as an interface between the flow cytometry system 100 and another computing device. Further, the control system 118 may serve as an interface between the flow cytometry system 100 and a user.

In some implementations, the control system 118 of the flow cytometry system 100 may also include communication link(s) 124 configured to send and/or receive information. The communication link(s) 124 may transmit data indicating the state of the various components of the flow cytometry system 100. For example, information from the two or more side scatter detection modules 110A-110D may be transmitted via the communication link(s) 124 to a separate device. Other diagnostic information indicating the integrity or health of various components of the two or more side scatter detection modules 110A-110D may be transmitted via the communication link(s) 124 to an external communication device.

In some implementations, the flow cytometry system 100 may receive information at the communication link(s) 124 that is then processed by the processor(s) 112. The received information may indicate data that is accessible by the processor(s) 112 during execution of the instructions stored by the non-transitory computer readable medium 120. Further, the received information may change aspects of the controller 126 that may affect the operating parameters of various components of the flow cytometry system 100. In some cases, the received information may indicate a query requesting a particular piece of information (e.g., the operational state of one or more of the components of the flow cytometry system 100). The processor(s) 112 may subsequently transmit the particular piece of information back out the communication link(s) 124.

In some cases, the communication link(s) 124 may include a wired connection. As such, the flow cytometry system 100 may include one or more ports to interface the communication link(s) 124 to an external device. The communication link(s) 124 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, Bluetooth, or a near-field communication (NFC) device.

During operation, the control system 118 may communicate with other systems of the flow cytometry system 100 via wired or wireless connections and may further be configured to communicate with one or more users of system. As one possible illustration, the control system 118 may receive an input (e.g., from the two or more side scatter detection modules 110A-110D of the flow cytometry system 100) indicating a change in operational status of the flow cytometry system 100. The input to control system 118 may be received via the communication link(s) 124. Based on this input, the control system 118 may perform operations to cause the flow cytometry system 100 to perform one or more tasks.

Operations of the control system 118 may be carried out by the processor(s) 112. Alternatively, these operations may be carried out by the controller 126, or a combination of the processor(s) 112 and the controller 126. In some implementations, the control system 118 may partially or wholly reside on a device other than the flow cytometry system 100, and therefore may at least in part control the flow cytometry system 100 remotely. Communication link(s) 124 may be used at least in part to carry out the remote communication.

As described above, the flow cytometry system 100 includes a processor 112 and a non-transitory computer readable medium 120 having stored therein instructions that are executable to cause the processor 112 to perform functions. In particular, the functions may include (i) determining, via the bubble sensor 115 positioned on the sample fluidic pathway 104, a presence of the separation gas 113 in the fluid in the sample fluidic pathway 104, and (ii) based on the determination of the presence of the separation gas 113, transitioning the visual indicator 125 from a first visual state to a second visual state.

In one example, the visual indicator 125 comprises a light-emitting diode (LED). In one such example, the first visual state comprises the LED turned on, and the second visual state comprises the LED turned off. In another example, the first visual state comprises the LED turned off, and the second visual state comprises the LED turned on. In another example, the first visual state comprises the LED turned on with a first color, and the second visual state comprises the LED turned on with a second color that is different than the first color.

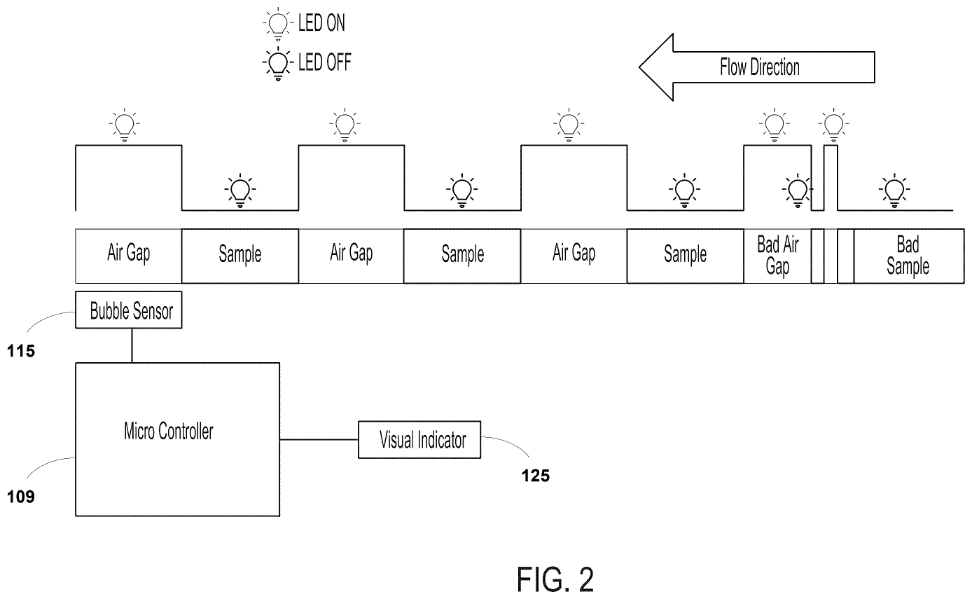

In one example, as shown in FIG. 2, the non-transitory computer readable medium 120 causes the processor 112 to further perform functions including generating separation gas timing data based on a plurality of detected aliquots of separation gas 113. In one such example, the non-transitory computer readable medium 120 causes the processor 112 to further perform functions including: (i) if the separation gas timing data indicates that the plurality of detected aliquots of separation gas 113 are evenly spaced, causing the visual indicator 125 to indicate that the flow cytometry system is operating properly, and (ii) if the separation gas timing data indicates that the plurality of detected aliquots of separation gas 113 are unevenly spaced, causing the visual indicator 125 to provide an error indication.

In one such example, causing the visual indicator 125 to indicate that the flow cytometry system is operating properly comprises the visual indicator 125 turning on at a regular interval, and causing the visual indicator 125 to provide an error indication comprises the visual indicator 125 turning on at an irregular interval. In another example, causing the visual indicator 125 to indicate that the flow cytometry system is operating properly comprises the visual indicator 125 having a first color, and causing the visual indicator to provide an error indication comprises the visual indicator 125 having a second color that is different from the first color.

As such, in addition to detecting presence of an air bubble, the system can detect “air gap quality” information that is also immediately provided to the user. The timing of the sampling is very precise and should result in well-defined gaps between samples 111 that are of uniform length. When the air gap is not good (i.e., broken in multiple pieces) the bubble sensor 115 will detect that and the visual indicator 125 will turn on at an irregular frequency. As shown in FIG. 2, in essence a “good” air gap defined by the separation gas 113 has consistent length and a “bad” air gap has inconsistent length. As such, consistent periodic blinking of the visual indicator 125 indicates the system is operating as intended, while inconsistent blinking of the visual indicator 125 indicates there is an issue (e.g., blinking at irregular intervals).

As discussed above, during sample collection, the flow cytometry system 100 will take a slug of sample 111 and then will take a slug of separation gas 113 (air gap), repeating this sequence for every sampling location in the well plate 117. The result is a series of slugs of samples 111 separated by series of separation gas 113 gaps. These samples 111 are being pumped to the flow cell 102, where the cytometer will use the two or more lasers 108A-108D to illuminate the samples 111, and the two or more side scatter detection modules 110A-110D will pick up the fluorescence light that the samples produce.

The sampling tubing (e.g., sample fluidic pathway 104) is placed inside the bubble sensor 115 such that the bubble sensor 115 can detect or sense across the entire cross section of the tubing. When an air gap 113 passes through the bubble sensor 115, the bubble sensor 115 changes its analog output. This analog signal is digitalized and filtered by the micro controller 109. The micro controller 109 uses the resulting value to determine if the signal is an air gap 113 and then turns on the visual indicator 125 to indicate to the user that the air gap 113 is passing therethrough.

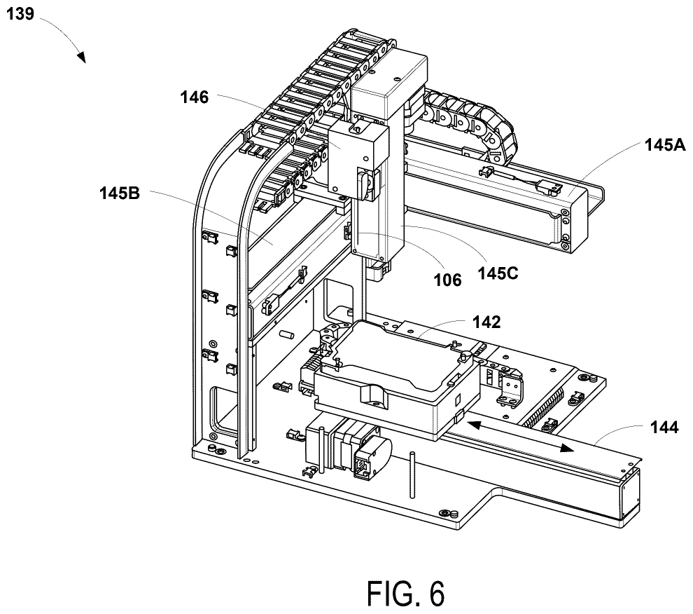

In operation, the user creates an experiment using the software and determines which locations in the well plate 117 will be sampled. The user customizes parameters for sampling, shaking, and cleaning, which are summarized on a worklist and provide an estimated protocol duration. The user loads a well plate 117 onto a plate shaker 142 (shown in FIG. 6) and initiates the run through the controller software. During the run, samples from each designated well are aspirated through the probe 106 and transported through the tubing 104 by way of the pump 119 to the engine for optical interrogation. The bubble sensor 115 detects air gaps between samples from different wells and provides a visual indicator 125 to the user of how the instrument run is going. Samples travel through the flow cell 102 and collect into a waste bottle on the fluidics station.

As slugs of sample 111 and air gaps 113 are passing through the tubing 104, the visual indicator 125 is on when the bubble sensor 115 is detecting an air gap 113 and off when it is detecting a slug of sample 111. In some arrangements, the opposite may be true (e.g., as slugs of sample 111 and air gaps 113 are passing through the tubing 104, the visual indicator 125 is off when the bubble sensor 115 is detecting an air gap 113 and on when it is detecting a slug of sample 111). In either case, since the air gaps 113 are periodic, this results in a periodic blinking of the visual indicator 125, which can be observed by the user to determine that the sampling is going as expected. Changes in the periodicity of the blinking can indicate a problem with the sampling, thus, users can react to it and make corrections as necessary, saving precious sample and testing time.

The air gap 113 is critical to separate the samples during the sampling process. A “bad” air gap can indicate a partial blockage of the tubing or a worn-out tubing. Determining the quality of the air gap 113 helps to ensure the sampling is going as expected. The visual indicator 125 blinking at irregular intervals can thereby be used to determine the quality of the air gap 113.

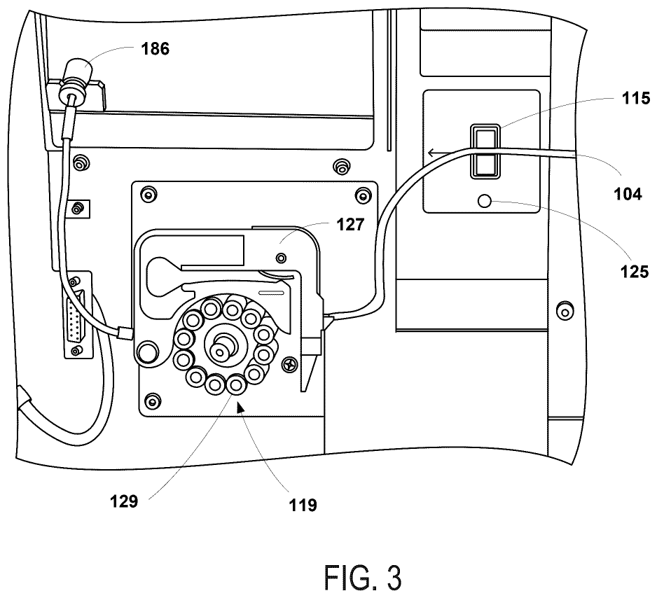

FIG. 3 illustrates an example bubble sensor 115, peristaltic pump 119, and visual indicator 125, according to an example embodiment. The peristaltic pump 119 comprises an electromechanical assembly used to aspirate the sample 111 and push it into the flow cell 102 in the cytometer. In operation, the cassette 127 of the pump 119 compresses the sample tubing 104 against the rollers 129, which are driven by the pump motor. When the pump 119 is not in use, a clamping mechanism on the side of the pump 119 allows the cassette 127 to release the pressure on the sample tubing 104 to extend the lifespan of the sample tubing 104. The sample 111 only interacts with the sample tubing 104. The sample 111 does not come in physical contact with any component in the pump assembly 119.

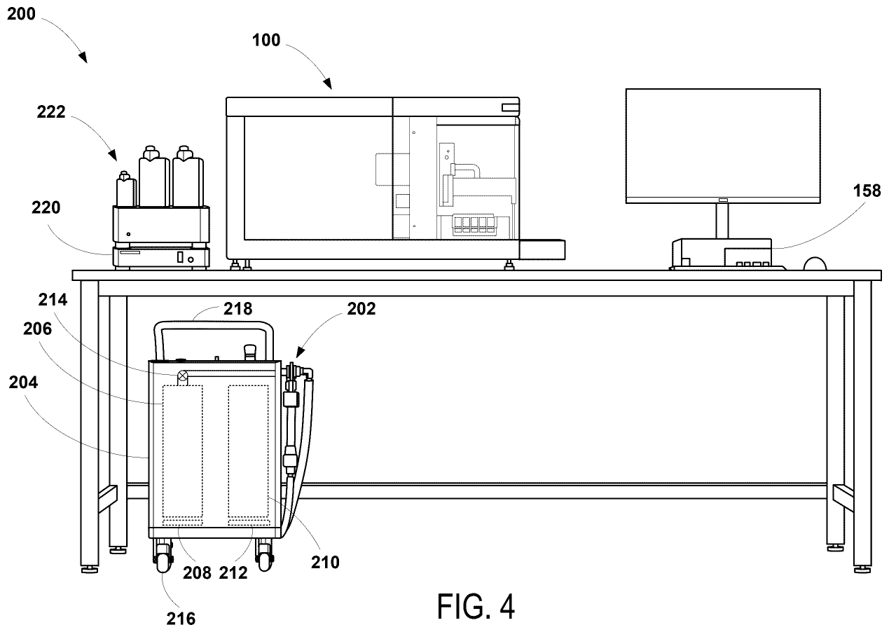

FIG. 4 illustrates an example workstation 200 including the flow cytometry system 100, according to an example embodiment. With reference to FIG. 4, the present disclosure provides a fluid storage module 202 configured to be in fluid communication with the flow cytometry system 100. The fluid storage module 202 includes (a) a housing 204, (b) a first tank 206 positioned within the housing 204 and configured to receive a first liquid via a first fluidic pathway, (c) a first load cell 208 positioned within the housing 204 and beneath the first tank 206, (d) a second tank 210 positioned within the housing 204 and configured to transmit a second liquid via a second fluidic pathway, (e) a second load cell 212 positioned within the housing 204 and beneath the second tank 210, and (f) a pump 214 in fluid communication with the first tank 206, where the pump 214 is configured to remove the first liquid from the first tank 206 via the first fluidic pathway.

In one example, a bottom surface of the housing 204 includes two or more wheels 216. In one example, the fluid storage module 202 further includes a handle 218 extending from the housing 204. A height of the handle 218 may be adjustable. In one example, the first liquid comprises a waste, and the second liquid comprises a sheath solution. The fluid storage module 202 may further include a switch to turn on the internal pump, which recirculates and pressurizes the waste liquid in a special fluid path inside storage module and an external triggered valve that allows the use to remove the first liquid from the first tank 206.

The first load cell 208 and the second load cell 212 are in communication with a controller 220 to transmit information including an amount of the first liquid in the first tank 206 and an amount of the second liquid in the second tank 210. The controller 220 automatically stops waste removal into the first tank 206 when an amount of the first liquid in the first tank 206 exceeds a threshold level to thereby prevent waste leaking from the first tank 206. The controller 220 further identifies any errors that may be within the system.

As described above, the workstation 200 includes liquid handling equipment designed to automatically supply and remove liquid to/from the fluidics station bottles. The workstation 200 includes a controller 220, a fluid storage module 202, as described above, that includes connections to the waste and sheath bottles on the fluidics station 222. The controller 220 may reside on a table next to the fluidics station 222 and the flow cytometry system 100. The fluid storage module 202 may reside on the laboratory floor adjacent to the table. The fluid storage module 202 stores two separate tanks, one for liquid buffer (i.e., sheath) and another one for waste. As described above, these tanks 206, 210 sit above load cells 208, 212, respectively. The controller 220 monitors the load cells 208, 212 to sense the liquid levels and notify users when buffer levels are low and when waste levels are high. The controller 220 automatically stops waste removal above a set level to prevent waste leaking from the first tank 206. The controller 220 further communicates with the flow cytometry system 100 to provide users with information about the tanks (i.e., remaining volume, etc.) and any errors the controller 220 has detected.

The fluid storage module 202 allows users to easily transport the heavy tanks 206, 210. As described above, the fluid storage module 202 is equipped with a handle 218 that can be adjusted in height making it more convenient to use to different people. The fluid storage module 202 is equipped with an electrical pump 214 that allows the users to pump the liquid waste to the disposition area, without having to lift the heavy tanks 206, 210. The fluidics design of the pump 214 allows the users to control the waste discharge using a triggered valve. The pump 214 pressurizes the system until the pressure exceeds the relief valve pressure that allows the waste liquid to return to the inlet side of the pump 214, allowing for continuous operation of the pump 214 and limiting the overall system pressure. The fluid storage module 202 may include quick-connect fluidics connectors that make it easier for users to connect/disconnect from the fluidics station 222 and quick-connect electrical connectors that make it easier for users to connect/disconnect from the controller 220.

While the workstation 200 described above may provide certain benefits to the end user, the flow cytometry system 100 is configured such that the flow cytometry system 100 can operate without the workstation 200 and controller 220 installed or connected.

The flow cytometry system 100 described above utilizes a fluidics system that needs frequent cleaning in between samples to minimize carryover in between samples. Moreover, the system can become partially or fully clogged due to accumulation of cells or cell components or other debris that is introduced into the fluidics during sample aspiration. To mitigate carryover and clogs, the instrument has predefined, built-in sequences to clean the fluidics system. The problem with existing cleaning sequences is that they are time fixed and there is no way for the user to know if the system is sufficiently clean.

Accordingly, in one example, the non-transitory computer readable medium 120 may cause the processor 112 to further perform functions including: (i) detecting a presence of a particle in the sheath fluidic pathway 131, (ii) detecting a pressure and/or a flow rate in the sheath fluidic pathway 131, and (iii) based on the detected presence of the particle in the sheath fluidic pathway 131 and the detected pressure and/or flow rate in the sheath fluidic pathway 131, adjusting one or more parameters of a fluid within the sheath fluidic pathway 131 to thereby clean the sheath fluidic pathway 131.

In another example, the present disclosure provides a method comprising (i) detecting a presence of a particle in a fluidic pathway, (ii) detecting a pressure and/or a flow rate in the fluidic pathway, and (iii) based on the detected presence of the particle in the fluidic pathway and the detected pressure and/or flow rate in the fluidic pathway, adjusting one or more parameters of a fluid within the fluidic pathway to thereby clean the fluidic pathway. In such an example, the fluidic pathway may comprise the sheath fluidic pathway 131 or the sample fluidic pathway 104, as non-limiting examples.

In one example, the detecting of a presence of a particle (e.g., a sample or portion of a sample) in the sheath fluidic pathway 131 is performed in the flow cell 102, as discussed above. In particular, one or more of the two or more lasers 108A-108D, the one or more forward scatter detectors 121, the one or more fluorescence detectors 123, and two or more side scatter detection modules 110A-110D may be used to detect the presence of the particle in the flow cell 102 that originates from the sheath fluidic pathway 131.

As shown in FIG. 1 and as discussed above, the flow cytometry system 100 may further include a first sensor 135 positioned on the sheath fluidic pathway 131, a second sensor 137 positioned on the sheath fluidic pathway 131, and a filter 140 positioned on the sheath fluidic pathway 131 between the first sensor 135 and the second sensor 137. In one such embodiment, the first sensor 135 and/or the second sensor 137 are configured to detect a pressure and/or a flow rate in the sheath fluidic pathway 131. The first sensor 135 and the second sensor 137 may each comprise a pressure sensor or a flow rate sensor, as non-limiting examples.

In use, the first sensor 135 may be used to detect whether or not the filter 140 is clogged. For example, if the first sensor 135 is a pressure sensor, the first sensor 135 can make a determination that the filter 140 is clogged if the pressure detected by the first sensor 135 exceeds a threshold pressure value. Similarly, if the first sensor 135 is a flow rate sensor, the first sensor 135 can make a determination that the filter 140 is clogged if the flow rate detected by the first sensor 135 is less than a threshold flow rate. The second sensor 137 may be used to detect whether or not the flow cell 102 is clogged. For example, if the second sensor 137 is a pressure sensor, the second sensor 137 can make a determination that the flow cell 102 is clogged if the pressure detected by the second sensor 137 exceeds a threshold pressure value. Similarly, if the second sensor 137 is a flow rate sensor, the second sensor 137 can make a determination that the flow cell 102 is clogged if the flow rate detected by the second sensor 137 is less than a threshold flow rate. Although the first sensor 135, the second sensor 137, and the filter are shown in FIG. 1 positioned on the sheath fluidic pathway 131, they may alternatively be placed on the sample fluidic pathway 104.

In one example, detecting a presence of a particle in the sheath fluidic pathway 131 includes detecting one or more of a size, a shape, and a fluorescence of the particle in the sheath fluidic pathway 131. In one example, the one or more parameters of the fluid within the sheath fluidic pathway 131 includes one or more of a temperature, a flow rate, a pressure, and a type of fluid.

In one example, the non-transitory computer readable medium 120 causes the processor 112 to further perform functions including: detecting a clog in the flow cell 102. In one such example, the non-transitory computer readable medium 120 causes the processor 112 to further perform functions including: increasing a pressure of the fluid on one side of the clog to thereby remove the clog. In another such example, the non-transitory computer readable medium 120 causes the processor 112 to further perform functions including: increasing a pressure of the fluid on both sides of the clog to thereby remove the clog. In another such example, the non-transitory computer readable medium 120 causes the processor 112 to further perform functions including: inducing turbulent flow of the fluid to thereby remove the clog. This is in contrast to the usual laminar flow of the system. In another such example, the non-transitory computer readable medium 120 causes the processor 112 to further perform functions including running the fluid in reverse to thereby remove the clog. Running the fluid in the reverse direction of the normal flow path can be particularly effective due to system fluidic pinch points (such as the small path in the flow cell 102) and a potentially shorter path from the clog to the inlet of the system as opposed to the outlet of the system. In all such examples, the flow cytometry system 100 may further include an auxiliary cartridge to receive the clog once ejected from the flow cytometry system 100 so that clog clearing can be performed in an automated manner without user intervention.

Using the methods described above, the cleanliness of the flow cytometry system 100 can be assessed during clean processes through live measurement of event count and/or sensors in the system such as pressure or flowrate sensors during the clean process. The information can be used in a feedback loop to enable dynamic cleaning of the flow cytometry system 100, in which the length and type of cleaning procedure is modified throughout the cleaning procedure to optimally clean the flow cytometry system 100 with minimal time and reagents.

To assess the cleanliness, events can be monitored on an ongoing basis throughout a cleaning procedure, where the number of events (e.g., detections of particles within the system) is expected to decrease as the clean proceeds. The event information may contain size, shape and fluorescence information about the type of event, through which can provide information about the type of debris, such as leftover sample or contamination in the system. Moreover, the live cleanliness measurement can be correlated to the current flow path being cleaned. Note however that the event count could also be low in the case of a clog due to limited flow in the system, hence monitoring of pressure and/or flow sensors in the system is also beneficial.

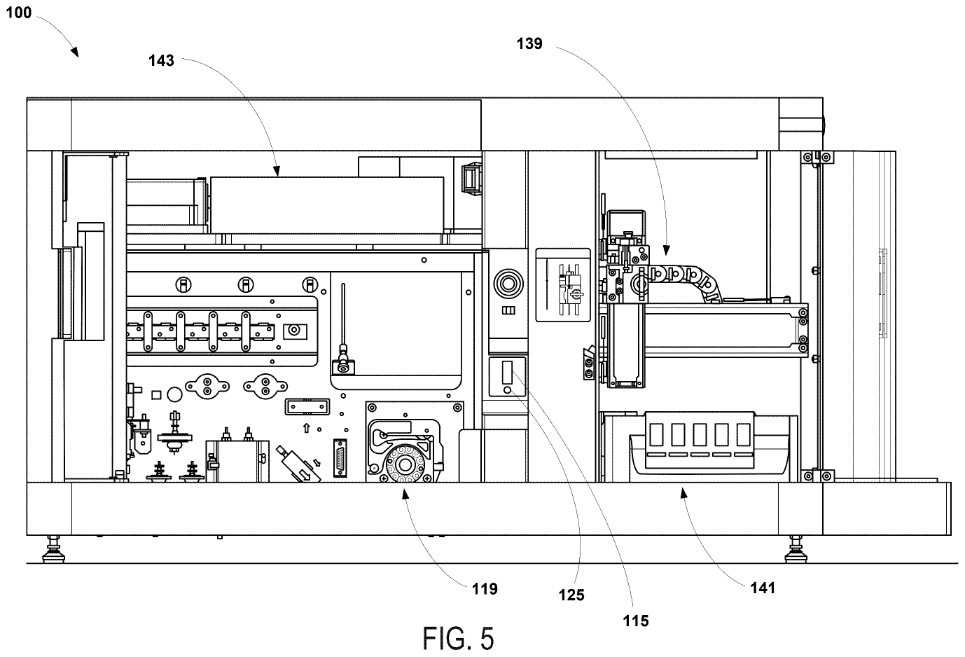

To optimally clean the flow cytometry system 100 based on the live cleanliness measurement, the cleaning procedure can proceed until the cleanliness measurement indicates the flow cytometry system 100 is clean. The flow cytometry system 100 can specifically clean the flow paths that are known to be dirty, and it can alter the type of cleaning based on the type of debris. For instance, different pressures and/or different types and temperatures of cleaning reagents can be used based on the measured one or more parameters of the fluid within the sample fluidic pathway 104. The cleaning reagents and the temperature control of them can be part of the enhanced rinse station 141, as shown in FIG. 5.

One specific type of system issue that needs extensive cleaning is the clog, which can be identified based on characteristic high pressures and low flow rates in the clog-blocked path as described above. Identification of the clog path is particularly important as placing a high pressure on the clog through pushing through the appropriate paths is critical for clog clearing.

FIG. 5 illustrates an example flow cytometry system 100 with a side covering removed, according to an example embodiment. FIG. 5 illustrates the pump 119, the bubble sensor 115, the visual indicator 125, the gantry system 139, the rinse station 141, and the engine 143 (that includes the flow cell 102), among other components. These components will now be discussed in additional detail.

FIG. 6 illustrates a gantry system 139 of an example flow cytometry system 100, according to an example embodiment. As shown in FIG. 6, the gantry system 139 includes a plate shaker 142 and a plate rail 144. The plate shaker 142 is an electromechanical assembly that allows the agitation of the sample to ensure uniform distribution of the sample within the well plate 117. The agitation is orbital. The plate rail 144 is an electromechanical assembly that allows the transportation of the plate shaker 142 with the well plate 117 from the loading position to the unloading position and vice versa.

As further shown in FIG. 6, the gantry system 139 further includes a probe 106. The probe 106 is a metal tube that is positioned into the well plate 117 to aspirate samples individually. The tubing (e.g., sample fluidic pathway 104) is a flexible plastic tube that transports the sample to the flow cell 102 in the engine 143. This tubing may be replaceable by the user. The gantry system 139 further includes a probe mount 146, which is an electromechanical assembly used to secure the probe 106 in place, enabling repeatability in position. The probe mount 146 has a mechanism that uses a sensor to detect when the probe 106 hits a surface (i.e. bottom of the well plate). The sensor is connected to the motion controller that stops the motion to prevent/reduce damage to the surface, as discussed in additional detail below. The gantry system 139 further includes an XYZ gantry, which is an electromechanical assembly comprised of motorized linear stages. In particular, the XYZ gantry comprises an x-axis gantry 145A, a y-axis gantry 145B, and a z-axis gantry 145C, as shown in FIG. 6. The stages are positioned such that the motion envelope covers all the possible locations in the well plate 117. The motion controller allows for communication with instrument software and controls the motors to position the probe 106 at the desired location.

In operation, the user loads their sample in a well plate 117 (e.g., 96 or 384 wells as non-limiting examples). The user unlocks the well plate lock mechanism (manually or via software) in the plate shaker 142 and places the well plate 117 onto the plate shaker 142. The user locks the well plate lock mechanism. This mechanism grabs onto the well plate 117 and prevents the well plate 117 from moving during shaking. The plate rail 144 transports the plate shaker 142 and well plate 117 to the sampling area, so sampling from the probe 106 can begin. During sampling, the plate shaker 142 will be enabled to ensure uniform distribution of the samples within the wells. Once the sampling is finished, the plate rail 144 will transport the plate shaker 142 and well plate 117 to the unloading position, so the well plate 117 can be replaced.

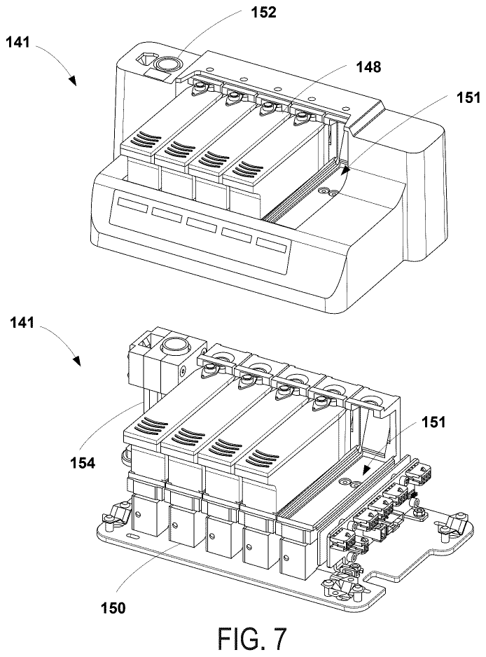

FIG. 7 illustrates a rinse station 141 of an example flow cytometry system 100, according to an example embodiment. As shown in FIG. 7, the rinse station 141 includes reagent cartridges 148, which are user replaceable containers providing different reagents to the probe 106 and tubing 104. The reagents coat the tubing 104 before sampling and clean the tubing afterwards. In one example, the reagent cartridges 148 comprise four cartridges (as shown in FIG. 7). The four cartridges may comprise a buffer cartridge, a flush cartridge, a clean cartridge, and a rinse cartridge. As shown in FIG. 7, the rinse station 141 may further include an auxiliary slot 151 that is configured to hold a fifth cartridge. In one example, the fifth cartridge may include marker beads to aid the software with sample identification in a well plate 117. In another example, the fifth cartridge may comprise the auxiliary cartridge described above that is configured to receive the clog once removed from the sample fluidic pathway 104.

The rinse station 141 further includes load cells 150, which are an electromechanical part used to weigh the reagent cartridges 148 and determine the volume of liquid inside. The weight is provided to the software of the system to thereby alert the user when the reagent cartridges 148 need to be replaced. The rinse station 141 further includes a tube holder 152, which is a recessed cavity to hold a standard 1.5 mL microcentrifuge tube. The 1.5 mL tubes are used for daily quality control of the system and for holding individual samples to be screened by the instrument. The rinse station 141 further includes a tube vortexer 154, which is an electromechanical assembly used to mix the contents of the 1.5 ml tube and resuspend beads in the 1.5 mL tube that have settled due to gravity.

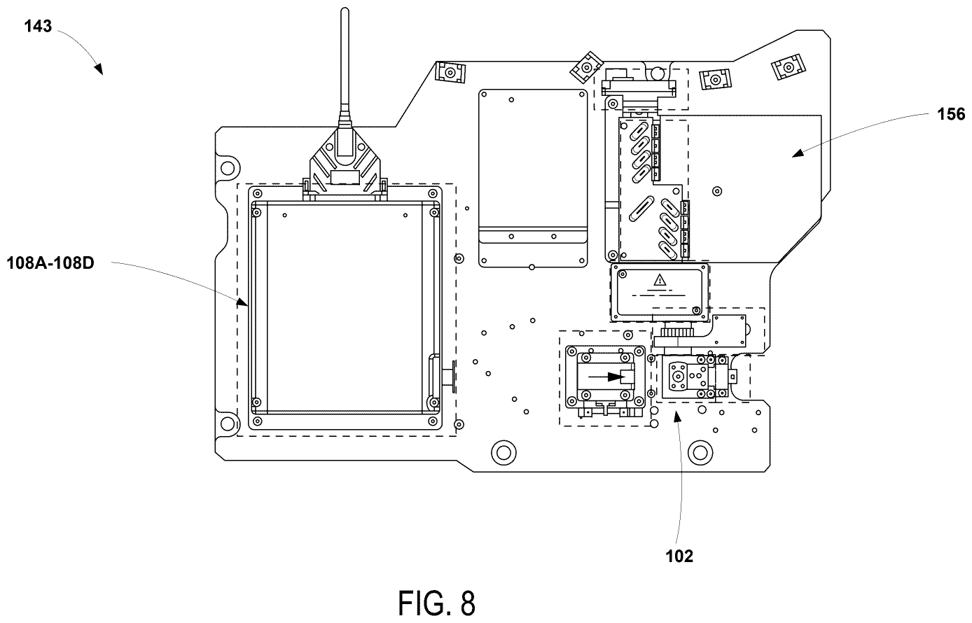

FIG. 8 illustrates an engine 143 of an example flow cytometry system 100, according to an example embodiment. The engine 143 includes two or more lasers 108A-108D as discussed above, which provide an optical arrangement consisting of light sources of different wavelengths (in this case, four different wavelengths) which interact with samples as they pass through the flow cell 102. The engine 143 further includes a flow cell 102, which is a chamber where particles from each sample on a well plate 117 are hydrodynamically focused to enable them to pass through in single file for real-time analysis. The engine 143 further includes photodetectors 156, which include an optoelectronic assembly responsible for converting light signals to electronic signals according to the scatter and fluorescent properties derived from laser interrogation of samples passing through the flow cell. The silicon photomultipliers employed in this instance can collect data in up to 25 fluorescent, forward scatter (particle size), and side scatter (particle granularity) channels.

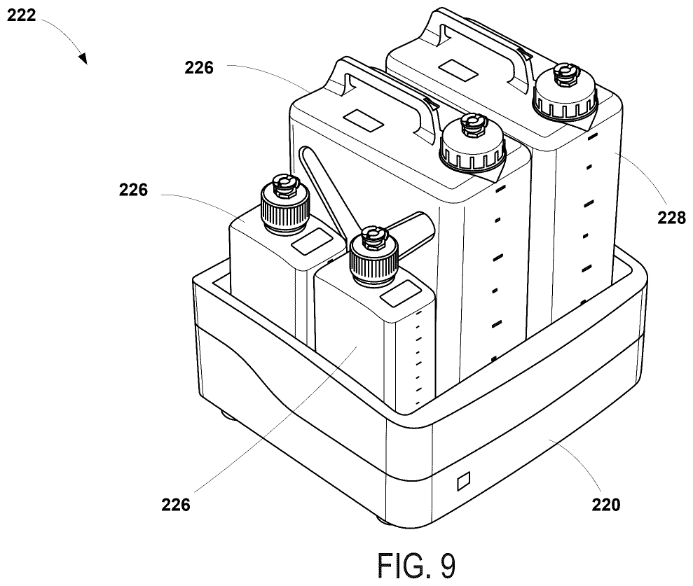

FIG. 9 illustrates a fluidics station 222 of an example flow cytometry system 100, according to an example embodiment. The fluidics station 222 includes a fluidics station controller 220, which is an electromechanical assembly holding reagent and waste bottles needed by the instrument. It communicates bottle volume levels via software. The fluidics station 222 further includes reagent bottles 226 that hold reagents that are essential inputs for instrument operation. One is for a sheath fluid (carrier fluid), which helps position sample particles in single-file in the flow cell. The other two smaller bottles hold fluids for routine cleaning of the engine 143. The fluidics station 222 further includes a waste bottle 228 that is the destination for all fluids used on the instrument, including sheath fluid, cleaning fluids, as well as samples and enhanced rinse station cartridge fluids aspirated by the probe 106. Contents are emptied and disposed of in accordance with local waste management regulations.

FIG. 10 illustrates various controllers of an example flow cytometry system 100, according to an example embodiment. The instrument controller 158 may comprise a desktop computer that houses the system software that the user interacts with to operate the flow cytometry system 100. The embedded computer 160 includes the non-transitory computer readable medium 120 that runs the software that controls the flow cytometry system 100. Moreover, it facilitates communications from the XYZ gantry 145A-145C, engine 143, plate shaker 142, and rinse station 141, which are directly plugged into it. The master controller 162 comprises a circuit board assembly hosting firmware used to control electromechanical components, such as the pump 119, bubble sensor 115, status light 172, work light 174, engine startup/shutdown, door lock, and fans. Finally, the rinse station controller 164 comprises a circuit board assembly hosting firmware used to control electromechanical components in the rinse station 141, such as the vortexer motor and reading load cell weight measurements of reagent cartridges 148.

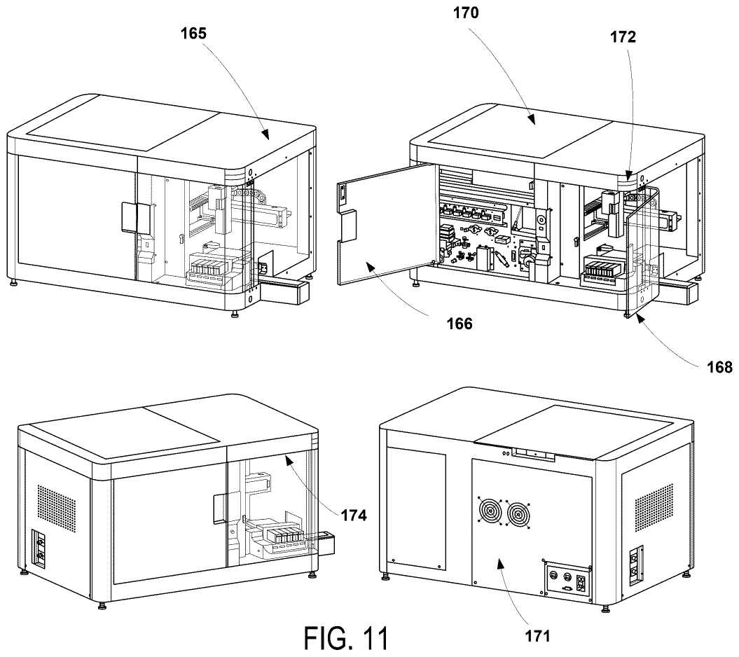

FIG. 11 illustrates various features of the enclosure of an example flow cytometry system 100, according to an example embodiment. As shown in FIG. 11, the flow cytometry system 100 may include a main body 165 of the enclosure that is a custom weldment made from aluminium. The design provides rigidity and allows for reliable optical performance. The flow cytometry system 100 further includes a cytometer access door 166 that allows access to the engine 143, from which the fluidics components can be replaced by the user (i.e., fluidlink connector 176 and tubing 104). The flow cytometry system 100 further includes a sample area door 168 that provides access to the sampling area, from which fluidics components can be replaced by the user (i.e., reagent cartridges 148, probe 106, and tubing 104). The flow cytometry system 100 further includes an optical bench access door 170 that provides access to the optical bench for laser alignment (interlock switch protected) and is intended to be accessed only by service personnel. The flow cytometry system 100 further includes an electronics access door 171 that provides access to the electronic components and is intended to be accessed only by service personnel. The flow cytometry system 100 further includes a status light 172 that comprises a multicolored LED that changes color to reflect the current instrument state.

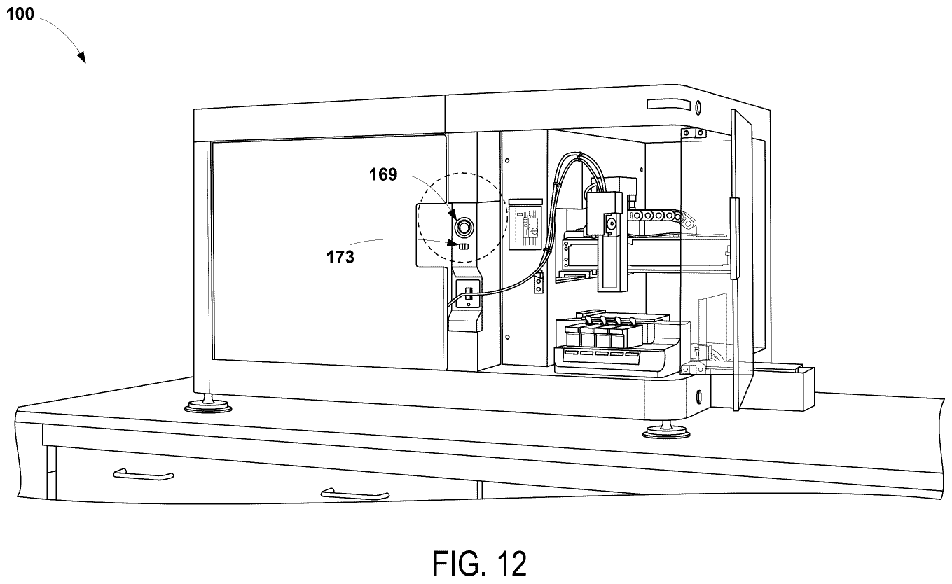

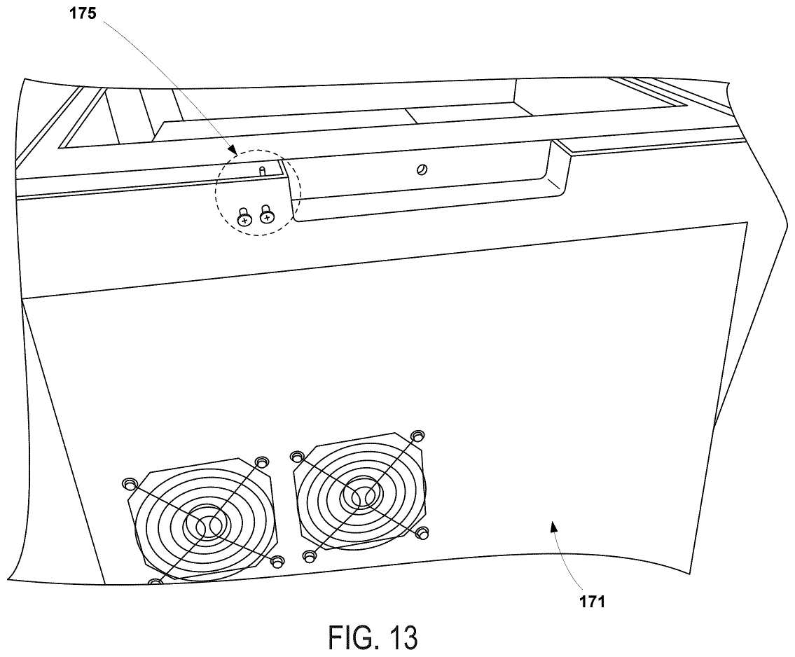

Further, as shown in FIG. 11, the system includes a work light 174 that provides additional illumination in the sampling area. Light intensity of the work light 174 can be adjusted to avoid damaging photosensitive samples. The work light 174 may be automated and provide a range of intensities (as opposed to a binary on/off arrangement). The sample area door 168 is interlocked by an optical sensor 173 and an electromagnetic lock 169, as shown in FIG. 12. The electromagnetic lock 169 energizes when the XYZ gantry 145A-145C is moving to prevent the user from accidentally opening the sample area door 168 at that time. FIG. 13 illustrates a laser interlock 175 that is engaged when the optical bench access door 170 is opened, and a message will appear to the user. The flow cytometry system will stop operation and alert the user if the laser interlock 175 is engaged.

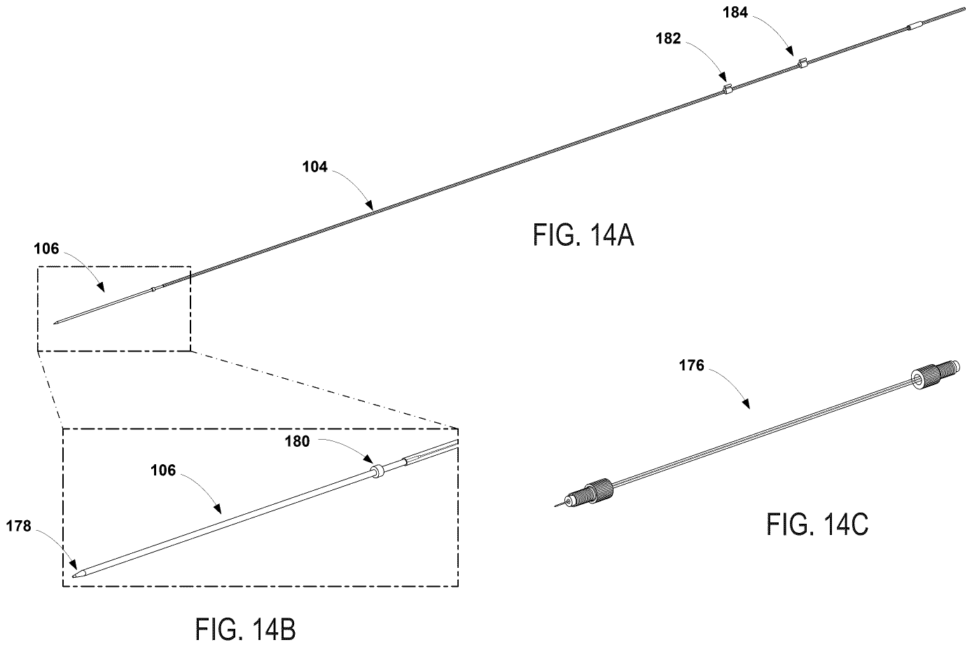

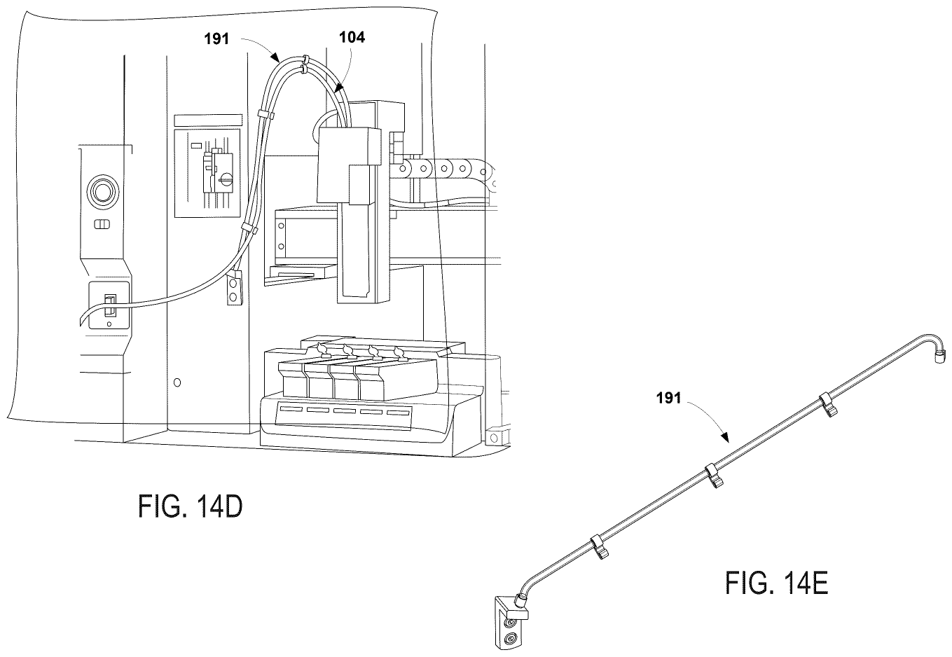

FIGS. 14A-14B illustrate a probe 106 and tubing 104 of an example flow cytometry system 100, according to an example embodiment. As shown in FIGS. 14A-14B, the probe 106 comprises a single wall with a tapered tip 178. A thickness of the single wall of the probe 106 prevents the probe from buckling when it encounters a solid surface (e.g., a bottom of the well plate 117). The thicker single wall of the probe 106 eliminates the need for an outer probe, which in turn helps to reduce clogging and carryover between sample pulls. As further shown in FIG. 14B, the probe 106 includes an alignment ring 180 at an end opposite the tapered tip. As discussed in additional detail below, the alignment ring 180 provides easy installation and removal of the probe 106 from the probe mount 146. As further shown in FIG. 14A, the probe 106 is coupled to tubing 104. The tubing 104 includes a first hard stop 182 and a second hard stop 184. The pump 119 may be positioned between the first hard stop 182 and the second hard stop 184, which enables the pump 119 to run in both directions (e.g., a first direction during normal operation of the system and a second direction during a clog removal operation).

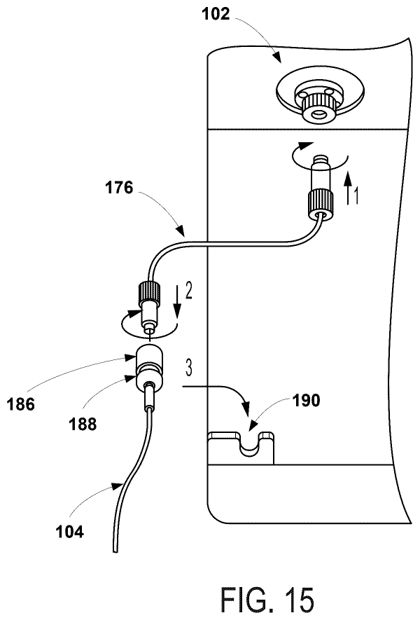

FIG. 14C illustrates a fluidlink connector 176, according to an example embodiment. The fluidlink connector 176 provides a connection between the tubing 104 and the flow cell 102. FIG. 15 illustrates a visual representation of a connection of the fluidlink connector 176 to the flow cell 102 on one side and the tubing 104 on the other side, according to an example embodiment. As shown in FIG. 15, the system may further include a coupler 186 that is positioned between the fluidlink connector 176 and the tubing 104. The coupler 186 may include a circumferential groove 188 that is configured to be removably positioned in a cutout 190 that is fixed to the flow cytometry system 100. Such an arrangement enables easy removal of the coupler 186 from the flow cytometry system 100 to untwist or otherwise adjust the tubing 104 and/or the fluidlink connector 176.

FIG. 14D illustrates a flexible sample tubing support 191, according to an example embodiment. FIG. 14E illustrates a close up view of the flexible sample tubing support 191 of FIG. 14D. The flexible sample tubing support 191 is configured to prop up the tubing 104 from the probe 106 as the XYZ gantry 145A-145C moves around the sampling area. The flexible sample tubing support 191 ensures that the tubing 104 does not kink or otherwise interfere with the XYZ gantry 145A-145C.

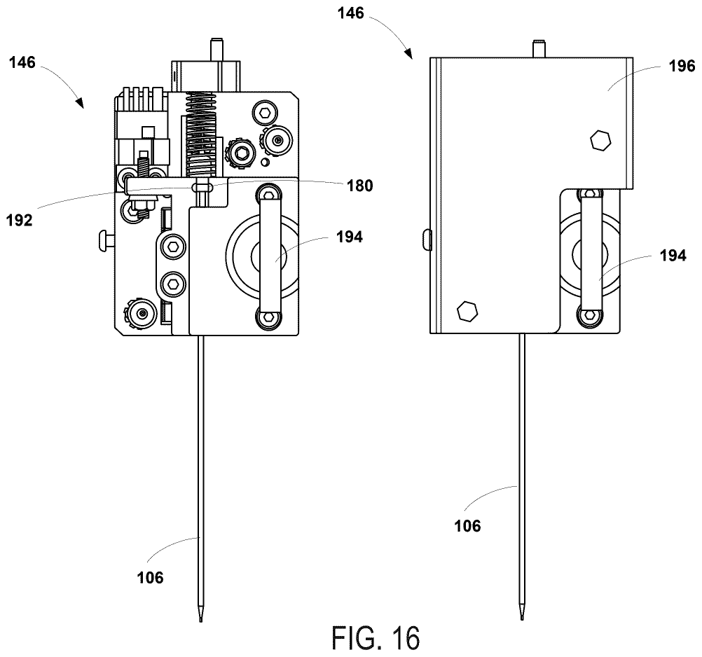

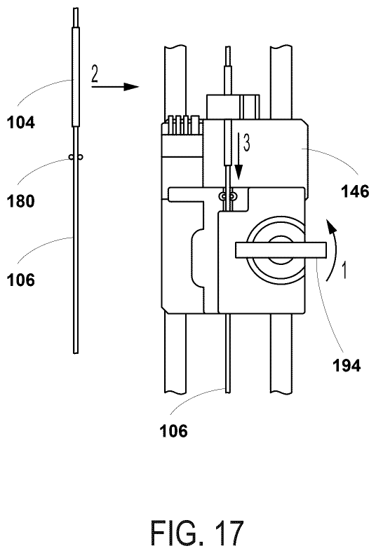

FIG. 16 illustrates a probe mount 146 of an example flow cytometry system 100, according to an example embodiment. As shown in FIG. 16, the alignment ring 180 of the probe 106 is positioned in a corresponding groove 192 in the probe mount 146. A knob 194 is then turned a quarter turn in a first direction to removably fix the probe 106 to the probe mount 146. When the probe 106 is to be removed, the knob 194 is turned a quarter rotation in a second direction, and the probe 106 can then be removed from the probe mount 146. As shown in FIG. 17, the probe mount 146 may further include a magnetic cover 196 that covers a portion of the probe 106 when in use. FIG. 17 illustrates a visual representation of the probe 106 being positioned in the probe mount 146, according to an example embodiment.

It should be understood that arrangements described herein are for purposes of example only. As such, those skilled in the art will appreciate that other arrangements and other elements (e.g., machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and examples have been disclosed herein, other aspects and examples will be apparent to those skilled in the art. The various aspects and examples disclosed herein are for purposes of illustration and are not intended to be limiting, with the true scope being indicated by the following claims, along with the full scope of equivalents to which such claims are entitled. It is also to be understood that the terminology used herein is for the purpose of describing particular examples only and is not intended to be limiting.

1. A flow cytometry system, comprising:
a flow cell;
a sample fluidic pathway in fluid communication with the flow cell;
a probe in fluid communication with the sample fluidic pathway, wherein the probe is configured to input a plurality of samples and aliquots of a separation gas between successive ones of the plurality of samples into the sample fluidic pathway;
a bubble sensor positioned on the sample fluidic pathway;
a visual indicator;
a processor; and
a non-transitory computer readable medium having stored therein instructions that are executable to cause the processor to perform functions when using the flow cytometry system, including:
determining, via the bubble sensor positioned on the sample fluidic pathway, a presence of the separation gas in a fluid in the sample fluidic pathway; and
based on the determination of the presence of the separation gas, transitioning the visual indicator from a first visual state to a second visual state.

2. The flow cytometry system of claim 1, wherein the visual indicator comprises a light-emitting diode (LED).

3. The flow cytometry system of claim 2, wherein the first visual state comprises the LED turned on, and wherein the second visual state comprises the LED turned off.

4. The flow cytometry system of claim 2, wherein the first visual state comprises the LED turned off, and wherein the second visual state comprises the LED turned on.

5. The flow cytometry system of claim 1, wherein the visual indicator is positioned adjacent to the bubble sensor.

6. The flow cytometry system of claim 1, wherein the non-transitory computer readable medium causes the processor to further perform functions including:
generating separation gas timing data based on a plurality of detected aliquots of separation gas.

7. The flow cytometry system of claim 6, wherein the non-transitory computer readable medium causes the processor to further perform functions including:
if the separation gas timing data indicates that the plurality of detected aliquots of separation gas are evenly spaced, causing the visual indicator to indicate that the flow cytometry system is operating properly; and
if the separation gas timing data indicates that the plurality of detected aliquots of separation gas are unevenly spaced, causing the visual indicator to provide an error indication.

8. The flow cytometry system of claim 6, wherein causing the visual indicator to indicate that the flow cytometry system is operating properly comprises the visual indicator turning on at a regular interval, and wherein causing the visual indicator to provide an error indication comprises the visual indicator turning on at an irregular interval.

9. The flow cytometry system of claim 6, wherein causing the visual indicator to indicate that the flow cytometry system is operating properly comprises the visual indicator having a first color, and wherein causing the visual indicator to provide an error indication comprises the visual indicator having a second color that is different from the first color.

10. The flow cytometry system of claim 1, further comprising a peristaltic pump coupled to the sample fluidic pathway and configured to move the plurality of samples through the sample fluidic pathway.

11.-18. (canceled)

19. A flow cytometry system, comprising:
a flow cell;
a sample fluidic pathway in fluid communication with the flow cell;
a sheath fluidic pathway in fluid communication with the flow cell;
a probe having a first end and a second end opposite the first end, wherein the second end of the probe is in fluid communication with the sample fluidic pathway;
a processor; and
a non-transitory computer readable medium having stored therein instructions that are executable to cause the processor to perform functions when using the flow cytometry system, including:
detecting a presence of a particle in the sheath fluidic pathway;
detecting a pressure and/or a flow rate in the sheath fluidic pathway; and
based on the detected presence of the particle in the sheath fluidic pathway and the detected pressure and/or flow rate in the sheath fluidic pathway, adjusting one or more parameters of a fluid within the sheath fluidic pathway to thereby clean the sheath fluidic pathway.

20. The flow cytometry system of claim 19, wherein detecting a presence of the particle in the sheath fluidic pathway includes detecting one or more of a size, a shape, and a fluorescence of the particle in the sheath fluidic pathway.

21. The flow cytometry system of claim 19, wherein the one or more parameters of the fluid within the sheath fluidic pathway includes one or more of a temperature, a flow rate, a pressure, and a type of fluid.

22. The flow cytometry system of claim 19, wherein the non-transitory computer readable medium causes the processor to further perform functions including:
detecting a clog in the flow cell.

23. The flow cytometry system of claim 22, wherein the non-transitory computer readable medium causes the processor to further perform functions including one or more of:
increasing a pressure of the fluid on one side of the clog to thereby remove the clog;
increasing a pressure of the fluid on both sides of the clog to thereby remove the clog;
inducing turbulent flow of the fluid to thereby remove the clog; and/or
running the fluid in reverse to thereby remove the clog.

24.-26. (canceled)

27. The flow cytometry system of claim 22, further comprising an auxiliary cartridge to receive the clog once removed.

28. The flow cytometry system of claim 19, wherein the probe is configured to input a plurality of samples and aliquots of a separation gas between successive ones of the plurality of samples into the sample fluidic pathway.

29. The flow cytometry system of claim 19, wherein the detecting of the presence of a particle in the sheath fluidic pathway is performed at the flow cell.

30. The flow cytometry system of claim 19, further comprising:
a first sensor positioned on the sheath fluidic pathway;
a second sensor positioned on the sheath fluidic pathway; and
a filter positioned on the sheath fluidic pathway between the first sensor and the second sensor, wherein the first sensor and/or the second sensor are configured to detect the pressure and/or the flow rate in the sheath fluidic pathway.

31. A method comprising:
detecting a presence of a particle in a fluidic pathway;
detecting a pressure and/or a flow rate in the fluidic pathway; and
based on the detected presence of the particle in the fluidic pathway and the detected pressure and/or flow rate in the fluidic pathway, adjusting one or more parameters of a fluid within the fluidic pathway to thereby clean the fluidic pathway.

32. The method of claim 31, wherein detecting a presence of the particle in the fluidic pathway includes detecting one or more of a size, a shape, and a fluorescence of the particle in the fluidic pathway.

33. The method of claim 31, wherein the one or more parameters of the fluid within the fluidic pathway includes one or more of a temperature, a flow rate, a pressure, and a type of fluid.

34. The method of claim 31, further comprising:
detecting a clog in a flow cell in fluid communication with the fluidic pathway.

35. The method of claim 34, further comprising one or more of:
increasing a pressure of the fluid on one side of the clog to thereby remove the clog;
increasing a pressure of the fluid on both sides of the clog to thereby remove the clog:
inducing turbulent flow of the fluid to thereby remove the clog; and/or running the fluid within the fluidic pathway in reverse to thereby remove the clog.

36.-38. (canceled)

39. The method of claim 34, further comprising:
ejecting the clog into an auxiliary cartridge in fluid communication with the fluidic pathway once removed.

40. The method of claim 31, wherein the detecting of the presence of a particle in the fluidic pathway is performed at a flow cell.

41. The method of claim 31, wherein a first sensor and/or a second sensor positioned on the fluidic pathway are configured to detect the pressure and/or the flow rate in the fluidic pathway.
